(19) United States
(12) Patent Application Publication
(10) Pub. No.: US 2026/0100322 A1
(43) Pub. Date: Apr. 9, 2026

(54) COLLECTOR FOR A TRAVELING WAVE TUBE AND TRAVELING WAVE TUBE WITH SUCH A COLLECTOR

(71) Applicant: Thales Deutschland GmbH, Ulm (DE)

(72) Inventor: Wolfgang DÜRR, Beimerstetten (DE)

(73) Assignee: Thales Deutschland GmbH, Ulm (DE)

(21) Appl. No.: 19/351,689

(22) Filed: Oct. 7, 2025

(30) Foreign Application Priority Data
Oct. 8, 2024 (DE) 10 2024 129 025.0

(51) Int. Cl. H01J 23/027

(52) U.S. Cl. CPC H01J 23/0275

(57) ABSTRACT

A collector for a traveling wave tube has at least two stages and an entrance opening for receiving an electron beam, which is followed by a first collector stage, wherein the first collector stage including magnetic focusing and a final collector stage being electrostatically designed, wherein a high-voltage connection of the first collector stage is led radially outwards in the region of the first collector stage adjacent to the final collector stage or adjacent to one or more further collector stages via a high-voltage feedthrough radially outward, wherein a ceramic insulation sleeve is connected to an outer side of an electrode of the last collector stage immediately adjacent and free of high-voltage feedthroughs.

### CROSS REFERENCE TO RELATED APPLICATIONS

Applicant claims priority under 35 U.S.C. § 119 of German Application No. 10 2024 129 025.0 filed Oct. 8, 2024, the disclosure of which is incorporated by reference.

### BACKGROUND OF THE INVENTION

### 1. Field of the Invention

The invention relates to a collector for a traveling wave tube and a traveling wave tube with such a collector.

### 2. Description of the Related Art

US 2007/0030058 A1 discloses an amplifier with an electron tube with an axial electron beam, which is equipped with a cathode and at least two collectors, and at least two direct current (DC) voltage sources. Each collector is connected to a DC voltage source that has a potential difference such that the further the collector is from the cathode, the smaller the potential difference between this collector and the cathode. The DC voltage sources are connected to each other at a common point located at the collector whose potential difference to the cathode is smaller but not zero.

US 2005/0067965 A1 refers to amplifier electron tubes that operate at microwave frequencies. The electron tube comprises an exhaust tube, which enables the creation of a vacuum inside the electron tube, an electron gun, which emits an electron beam inside the electron tube, and a collector, which directly intercepts a first part of the electron beam. The pumping tube repels a second part of the electron beam toward the collector. All electrodes of the collector are connected to a voltage source via laterally arranged connecting elements.

WO 2013/104637 A1 and DE 10 2012 100 132 A1 describe a collector for a traveling wave tube and a traveling wave tube with such a collector. A structure is specified in which at least a first collector stage has magnetic beam focusing and a smaller diameter, and at least one further collector stage is designed with a significantly larger diameter than the first collector stage.

U.S. Pat. No. 6,094,009 A describes a collector for collecting an electron beam in a traveling wave tube. The collector has an input end for receiving the electron beam from the traveling wave tube. The collector also has a plurality of stages that are biased to predetermined voltages and are arranged along a common collector axis and are located at different axial positions relative to the input end. One stage is biased with a more negative voltage than a subsequent stage that is axially further away from the input end to create an electrostatic focusing lens for focusing the electron beam onto subsequent stages, thereby increasing the collection efficiency of the collector.

DE 698 16 912 T2 shows a collector for collecting an electron beam in a traveling wave tube. The collector has an input end for receiving the electron beam from the traveling wave tube. The collector also has a plurality of stages that are biased to specific voltages, arranged along a common collector axis, and located at different axial positions relative to the input end. One stage is biased with a more negative voltage than a subsequent stage positioned further axially away from the input end in order to create an electrostatic focusing lens that focuses the electron beam onto subsequent stages, thereby increasing the collection efficiency of the collector.

DE 38 77 004 T2 shows an electron collector having four axially symmetrical electrodes with off-axis openings that receive an electron beam. By applying a voltage to each electrode that is successively lower than that applied to the cathode that generates the electron beam, an electrostatic field is created that efficiently deflects the beam electrons onto the electrodes, where they are collected.

U.S. Pat. No. 5,780,970 A describes a multi-stage recessed collector for receiving energy from a small, circulating electron beam, which uses multiple electrodes with different potentials to sort the individual electrons based on their total energy level. Magnetic field generating coils for generating magnetic fields and magnetic iron for magnetic field shaping produce adiabatic and controlled non-adiabatic transitions of the incident electron beam to further facilitate sorting.

DE 1 791 080 B shows a system for generating a spatial periodic magnetic field for focusing the electron beam of a high-power klystron by arranging a number of annular magnetic rings with axial magnetization in the same direction coaxially around the drift tubes between resonance cavities.

### SUMMARY OF THE INVENTION

Based on this prior art, the inventor has now set himself the object of creating a collector or a traveling wave tube with such a collector with improved high-voltage insulation.

This object is solved by a collector for a traveling wave tube according to the invention. Further advantageous embodiments of the invention are discussed below. These can be combined with each other in a technologically meaningful way. The description, in particular in conjunction with the drawing, further characterizes and specifies the invention described in the claims.

According to the invention, a collector for a traveling wave tube is specified which has at least two stages, which has an entry opening for receiving an electron beam, which is followed by a first collector stage, wherein the first collector stage comprises magnetic focusing and a final collector stage is designed electrostatically, wherein a high-voltage connection of the first collector stage is led radially outward in the area of the first collector stage adjacent to the last collector stage or adjacent to a further collector stage via a high-voltage feedthrough, wherein a ceramic insulating shell is connected directly adjacent to and free of high-voltage feedthroughs on an outer side of the last collector stage.

According to the invention, an at least two-stage collector is used which can be operated as a collector in a traveling wave tube. The first collector stage has magnetic focusing for concentrating an electron beam generated in the traveling wave tube. In this way, it is possible to design the first collector stage more compactly than an electrostatic collector stage. The space gained in this way is now used to provide a high-voltage feedthrough for supplying the first collector stage. The high-voltage feedthrough, which is routed radially outward, has improved insulation properties compared to axial feedthroughs. In this way, it is also possible to attach the ceramic insulation shell of the adjacent collector stage, which in the case of a two-stage collector is the last collector stage, without the axial clearance customary in the prior art, which creates a high-voltage feed there that is led to an end of the collector opposite an entry opening of the electron beam. According to the invention, only the last collector stage is supplied at this end of the collector. Due to the lack of free space in the ceramic insulation sleeve, the insulation of the high-voltage-carrying components of the collector stages against the surrounding ground potential is improved. The term “immediately adjacent” should be understood here to mean that there is no free space between the outside of the last collector stage and the ceramic insulation shell. Ideally, the ceramic insulation sleeve thus lies flat on the last collector stage. This not only improves the insulation of the high-voltage components of the collector stages, but also allows the ceramic insulation sleeve to be designed with a smaller diameter, which saves space in the traveling wave tube according to the invention.

According to an embodiment of the invention, the first collector stage has a smaller diameter than the last or the one or more further collector stages.

Magnetic focusing allows the first collector stage to be reduced in size in several ways. In addition to a smaller axial installation space, the diameter of the first collector stage can also be reduced. Furthermore, magnetic focusing of the electron beam can be used to achieve an asymmetry between incoming and returning electrons, reducing the probability of electrons returning from the entry opening, which results in higher efficiency of the collector when used in the traveling wave tube.

According to a further embodiment of the invention, a ring magnet is arranged between the opening and the high-voltage connection for magnetic focusing and can be moved axially.

In this way, the focusing of the electron beam can be individually adjusted during commissioning.

According to a further embodiment of the invention, the collector stages are provided at least in sections with further ceramic insulation shells and with a metallic outer surface.

Due to the lack of free space in the ceramic insulation material of the last collector stage, as already described above, the collector has a compact design which, when fitted with a metallic outer surface, has improved thermal properties, as these can be used for heat dissipation.

According to a further embodiment of the invention, the collector is designed with at least three stages, with the high-voltage connections of the one or more further collector stages being routed radially outwards via high-voltage bushings.

In this way, a compact design of a multi-stage collector is achieved.

According to a further embodiment of the invention, the high-voltage connection of the first collector stage and the high-voltage connection or connections of the one or more further collector stages are arranged in such a way that they divide a circle imagined in a plane perpendicular to the electron beam into circular sectors of equal size.

Accordingly, the distance between the live parts is optimized to minimize the risk of voltage jumps.

According to a further embodiment of the invention, the first collector stage is arranged at an angle to the electron beam.

According to a further embodiment of the invention, the one or more further collector stages are at least partially provided with magnetic focusing. In this case, all further collector stages may also be designed with magnetic focusing.

The invention is suitable for different configurations of collectors, which may have magnetic or electrostatic further collector stages, including mixed forms.

Furthermore, a traveling wave tube is specified which has an electron beam source, a delay line, and a collector as described above.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a first embodiment of the invention with a two-stage collector in a sectional view;

FIG. 2 shows a further embodiment of the invention with a three-stage collector in a sectional view;

FIG. 3 shows a further embodiment of the invention with a five-stage collector in a sectional view;

FIG. 4 shows the embodiment from FIG. 3 in a schematic top view from an axial direction; and

FIG. 5 shows an embodiment of a collector according to the invention in a traveling wave tube in a schematic representation.

### DETAILED DESCRIPTION OF PREFERRED EMBODIMENTS

In the figures, identical or functionally equivalent components are designated by the same reference numerals.

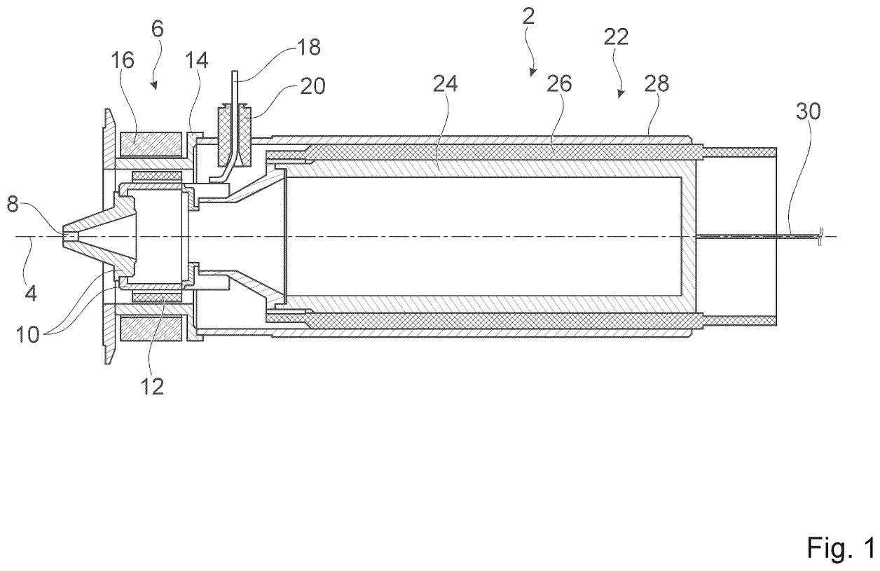

FIG. 1 shows a collector 2 in a sectional view. The sectional plane is arranged along an axial direction 4, which essentially corresponds to the direction of an incident electron beam. In this embodiment, collector 2 is designed in two stages. The first collector stage 6 has an entry opening 8 through which the electron beam can enter the collector 2. In addition to electrodes 10, the first collector stage 6 has a ceramic insulation shell or sleeve 12, which is connected to a metallic outer shell or surface 14. A first ring magnet 16 is arranged outside the metallic outer shell 14. The electrodes 10 of the first collector stage 6 are supplied with high voltage via a high-voltage connection 18, which is fed radially into the interior of the collector 2 via a ceramic feedthrough 20.

The design of the second and, in this case, also last collector stage 22 of the collector 2 differs from the first collector stage 6 in that an electrostatic design has been chosen here. The last collector stage 22 has further electrodes 24 that can be supplied with high voltage via a further high-voltage connection 30. The further high-voltage connection 30 is located approximately in the center of one axial end of the collector 2. To insulate the last collector stage 22, the further electrode 24 is surrounded by a ceramic insulating shell or sleeve 26, which is connected to a further metallic outer sleeve or surface 28. The further metallic outer sleeve 28 can be electrically connected to the metallic outer sleeve 14.

Magnetic focusing allows the first collector stage 6 to be designed compactly, creating space for the high-voltage connection 18. This can be determined based on the outer diameter of the first collector stage, whereby, for example, the outer diameter of the ceramic insulation sleeve 12 can be used as a measure. Because the first high-voltage connection 18 is routed radially outward between the first collector stage 6 and the last collector stage 22, it is not necessary to provide free spaces inside the ceramic insulation shell 26, as in the prior art, through which the high-voltage line would be routed to the first collector stage. In this way, both the high-voltage resistance of the collector 2 can be increased and the design of the last collector stage 22 can be optimized in terms of its space requirements.

An asymmetrical design of the field of the first ring magnet 16 improves the efficiency of the collector, as it reduces the probability that electrodes can return in the direction of an electron beam source. The metallic outer surface 14 and the further metallic outer surface 28 improve the thermal properties of the collector 2 in terms of heat dissipation.

The first ring magnet 16 can be slightly movable in the axial direction so that the focus of the first collector stage 6 can be individually adjusted during commissioning.

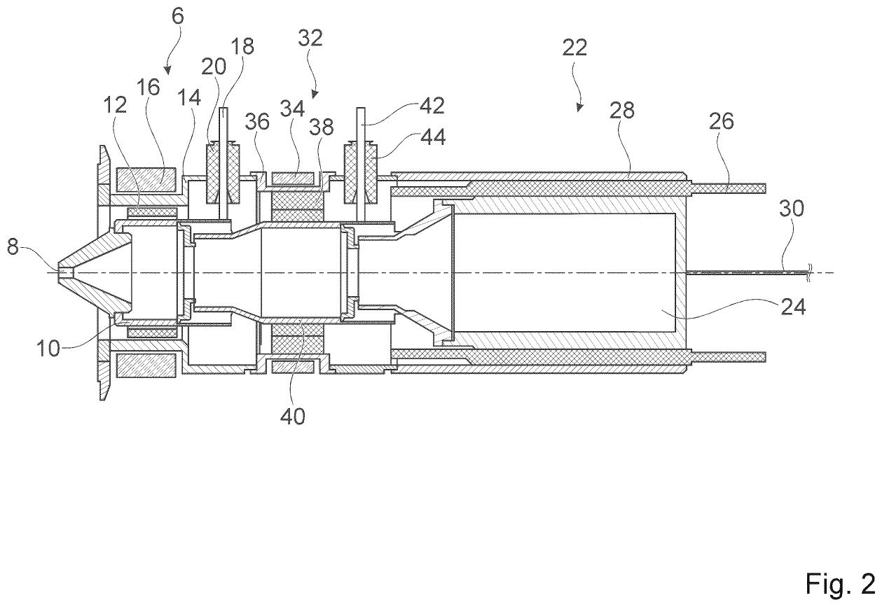

The structure shown in FIG. 2 corresponds to a three-stage collector. In addition to the first collector stage 6 and the last collector stage 22, which are constructed as shown in FIG. 1, a further collector stage 32 is provided here as a second collector stage, which is arranged between the first collector stage 6 and the last collector stage 22. The further collector stage 32 again features magnetic focusing by means of a further ring magnet 34. The further ring magnet 34 is arranged over a further metallic outer shell 36, which is connected to an further ceramic insulation shell 38 that electrically insulates the further electrodes 40 of the further collector stage 32. The first collector stage 6 may have a smaller outer diameter than the second collector stage, which can be determined based on the outer diameters of the ceramic insulation shell 12 and the further ceramic insulation shell 38.

The high-voltage supply to the further electrodes 40 is again provided via a further high-voltage connection 42, which is routed via a further high-voltage feedthrough 44 pointing radially outwards. The further high-voltage feedthrough 44 is again arranged between the further ring magnet 34 and the last collector stage 22. Unlike in FIG. 2, the first high-voltage feedthrough 20 and the further high-voltage feedthrough 44 can be arranged parallel to each other but point in different directions, so that the supply lines can be routed on opposite sides of the collector 2.

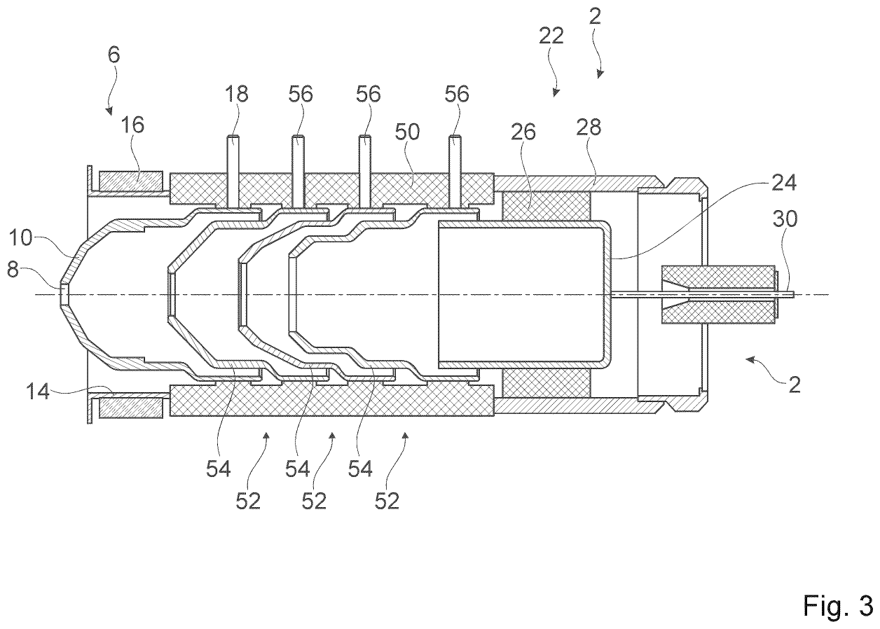

FIG. 3 shows a further embodiment of the collector 2 according to the invention. This collector 2 is designed with five stages. Here, the first collector stage 6 is again designed with magnetic focusing by means of a ring magnet 16, which is movably arranged on the metallic outer surface 14, preferably during commissioning. The high-voltage connection 18 of the first electrode 10 is again routed radially outward adjacent to the ring magnet 16. Here, the high-voltage connection 18 is routed through a further ceramic insulation sleeve 50.

The second to fourth collector stages, which are collectively referred to below as further collector stages 52, are each designed to be electrostatic and have further electrodes 54 inside them, each of which is connected to further high-voltage connections 56 in the further ceramic insulation sleeve 50.

The last collector stage 22 essentially follows the description in FIG. 1 and has, immediately adjacent to the further ceramic insulation shell 50, the further metallic outer surface 28, the ceramic insulation shell 26, and the last collector electrode 24, which is connected to the high-voltage connection 30.

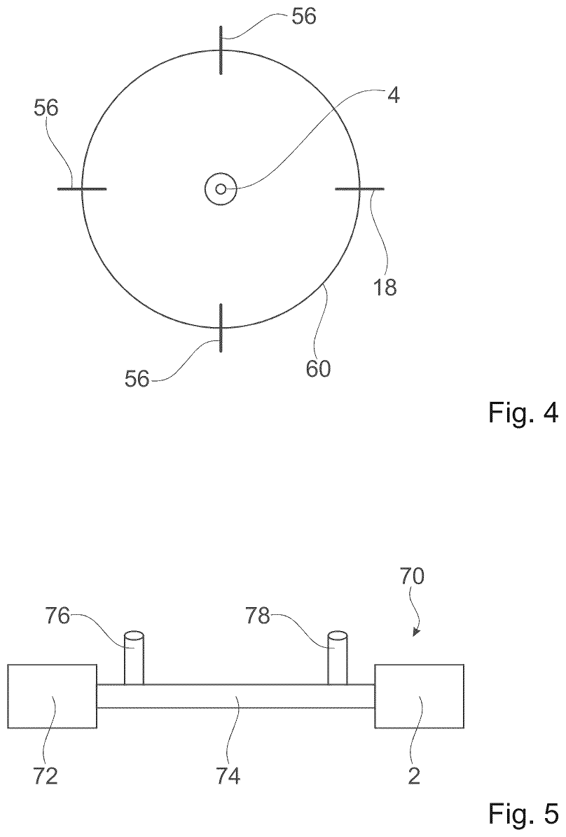

As shown in FIG. 4, the further high-voltage connections 56 can be spatially arranged together with the first high-voltage connection 18 in such a way that their distance from each other is maximized. In a plane perpendicular to the axial direction 4, the high-voltage terminals 56 and 18 would be arranged on an imaginary circle or circuit 60, which is divided by them into equal circular sectors. Such an arrangement can of course also be created with a different number of high-voltage connections, whereby the imaginary circle 60 is not divided into 90° sectors, but for example into 120° sectors in the case of a four-stage collector or 180° sectors in the case of a three-stage collector.

FIG. 5 shows collector 2 according to the invention in a traveling wave tube 70. The traveling wave tube 70 has an electron source 72 connected to a delay line 74. Collector 2 is arranged at the end of the delay line 74. An input signal can be fed via a high-frequency connection 76, which leaves the traveling wave tube as an output signal via the further high-frequency connection 78.

As shown in the previous embodiments, the invention can be used with differently configured collector arrangements. What they have in common is that the first stage has magnetic focusing on and that in the last, electrostatically designed stage, no high-voltage lines from previous stages pass by the outside.

The features described above and in the claims, as well as those apparent from the illustrations, can be advantageously implemented both individually and in various combinations. The invention is not limited to the embodiments described but can be modified in many ways within the scope of the knowledge of a person skilled in the art.

Although only a few embodiments of the present invention have been shown and described, it is to be understood that many changes and modifications may be made thereunto without departing from the spirit and scope of the invention.

### LIST OF REFERENCE NUMERALS

2 Collector
4 Axial direction
6 First collector stage
8 Entry opening
10 First electrode
12 Insulation sleeve
14 Outer surface
16 Ring magnet
18 First high-voltage connection
20 First high-voltage feedthrough
22 Further collector stage
24 Further electrode
26 Further insulation sleeve
28 Further outer surface
30 Further high-voltage connection
32 Further collector stage
34 Further ring magnet
36 Further outer shell
38 Further insulation shell
40 Further electrodes
42 Further high-voltage connection
44 Further high-voltage feedthrough
50 Further insulation sleeve
52 Further collector stages
54 Further electrodes
56 Further high-voltage connections
60 Circuit
70 Traveling wave tube
72 Electron source
74 Delay line
76 High-frequency connection
78 High-frequency connection

What is claimed is:

1. A collector (2) for a traveling wave tube (70), which has at least two stages and which has an inlet opening (8) for receiving an electron beam, which is connected to a first collector stage (6), wherein the first collector stage (6) comprising magnetic focusing and a final collector stage (22) being designed electrostatically, wherein a high-voltage connection (18) of the first collector stage (6) is led radially outwards in the region of the first collector stage (6) adjacent to the final collector stage (22) or adjacent to one or more further collector stages (32; 52) via a high-voltage feedthrough (20), wherein a ceramic insulation sleeve (26) is connected to an outer side of an electrode (24) of the last collector stage (22) immediately adjacent thereto and free of high-voltage feedthroughs.

2. The collector according to claim 1, wherein the first collector stage (6) has a smaller outer diameter on a further ceramic insulation sleeve (12) than the last or the one or more further collector stages (22; 32; 52).

3. The collector according to claim 1, wherein a ring magnet (16) is arranged between the inlet opening (8) and the high-voltage connection (18) for magnetic focusing and is axially displaceable.

4. The collector according to claim 1, wherein the collector stages are provided at least in sections with further ceramic insulation sleeves (12; 38; 50) and with a metallic outer surface (14) or a further metallic outer surface (28; 36).

5. The collector according to claim 1, which is designed with at least three stages, wherein the high-voltage connections (42; 56) of the one or more further collector stages (32; 52) are led radially outwards via high-voltage bushings.

6. The collector according to claim 5, in which the high-voltage connection (18) of the first collector stage and the high-voltage connection(s) (42; 56) of the one or more further collector stages are arranged in such a way that they divide a circle (60) imagined in a plane perpendicular to the electron beam into circular sectors of equal size.

7. The collector according to claim 1, wherein the one or more further collector stages (32) are at least partially provided with magnetic focusing.

8. The collector according to claim 1, wherein the one or more further collector stages (32) are at least partially provided with electrostatic focusing.

9. The collector according to claim 7, wherein either all further collector stages are designed with magnetic focusing or all further collector stages are designed with electrostatic focusing.

10. A traveling wave tube (70) comprising an electron beam source (72), a delay line (74), and the collector (2) according to claim 1.
